(19) United States
(12) Patent Application Publication
(10) Pub. No.: US 2009/0001068 A1
(43) Pub. Date: Jan. 1, 2009

(54) APPARATUS AND METHODS FOR COOLING AN OVEN CONVEYOR MOTOR

(76) Inventor: Marcus E. BRAMHALL, Dallas, NC (US)

Correspondence Address: HESLIN ROTHENBERG FARLEY & MESITI PC, 5 COLUMBIA CIRCLE, ALBANY, NY, 12203, US

(21) Appl. No.: 12/147,188

(22) Filed: Jun. 26, 2008

Related U.S. Application Data
(60) Provisional application No. 60/946,912, filed on Jun. 28, 2007.

(51) Int. Cl. F27D 5/00

(52) U.S. Cl. 219/392

(57) ABSTRACT

An oven, in one embodiment, includes a housing having a first opening, a second opening, and a heat treating chamber disposed between the first opening and the second opening. A conveyor motor is operably connected to the conveyor for transporting the plurality of products from the first opening, into the heat treating chamber, and out the second opening. A heating source is provided for heating the plurality of products passing through the heat treating chamber. A shroud is disposed around the conveyor motor and includes at least one inlet and at least one outlet. At least one fan is provided for forcing cooling air into the at least one inlet, around the conveyor motor, and out the at least one outlet of the shroud for cooling the motor. Methods for treating a plurality of products are also disclosed.

### CLAIM TO PRIORITY AND CROSS-REFERENCE TO RELATED APPLICATIONS

This application claims the benefit of U.S. Provisional Application No. 60/946,912, filed Jun. 28, 2007, entitled “Apparatus And Methods For Cooling An Oven Conveyor Motor”, which application is hereby incorporated in its entirety herein by reference.

This application is also related to commonly owned U.S. patent application Ser. No. 12/111,490, entitled “Ovens, Burner Tube Assemblies, And Methods For Delivering Air To A Gas Power Burner,” by Bramhall; U.S. patent application Ser. No. 12/111,497, entitled “Ovens Having A Cold Air Return Baffle And Methods For Circulating Air In An Oven,” by Bramhall; U.S. patent application Ser. No. 12/111,501, entitled “Ovens, Finger Ducts Therefor, And Methods For Distributing Air in A Finger Duct” by Bramhall; and U.S. patent application Ser. No. 12/111,506, entitled “Methods For Moving Ovens, And Ovens Having Means For Releasably Attaching To A Plurality Of Casters,” by Bramhall, which applications are hereby incorporated in their entirety herein by reference.

### FIELD OF THE INVENTION

This invention relates generally to ovens, and more specifically, to ovens having a conveyor for heat treating products and may include food preparation ovens.

### BACKGROUND OF THE INVENTION

Ovens for heat treating products oftentimes employ means for heating the oven. Food preparation ovens such as food preparation ovens for preparing pizza and other types of food products often employ jets of hot gaseous fluid such as hot air for baking or cooking the food product. Often the product or food is typically conveyed on a conveyor through the oven in which the conveyor is moved by a conveyor motor.

Ovens having a conveyor typically include the conveyor motor covered in a shroud. The shroud includes openings on a rear vertical surface such as louvers in which air movement around the conveyor motor is simply due to the “natural convection” or “free connection” of heating air out of the upper louvers and cooler air into the lower louvers. In particular, the heat is carried by the circulation of air due to buoyancy from density changes in the heated air compared to the cooler air induced by the heating.

There is a need for further ovens having a conveyor and for cooling the conveyor motor.

### SUMMARY OF THE INVENTION

The present invention, in a first aspect, is directed to an oven for heat treating a plurality of products. The oven includes a housing having a first opening, a second opening, and a heat treating chamber disposed between the first opening and the second opening. A conveyor extends from the first opening, through the heat treating chamber, and out the second opening for supporting the plurality of products. A conveyor motor is operably connected to the conveyor for transporting the plurality of products from the first opening, into the heat treating chamber, and out the second opening. A heating source is provided for heating the plurality of products passing through the heat treating chamber. A shroud is disposed around the conveyor motor and includes at least one inlet and at least one outlet. At least one fan is provided for forcing cooling air into the at least one inlet, around the conveyor motor, and out the at least one outlet of the shroud for cooling the conveyor motor.

The present invention, in a second aspect, is directed to an oven for heat treating a plurality of products. The oven includes a housing having a first opening, a second opening, and a heat treating chamber disposed between the first opening and the second opening. A conveyor extends from the first opening, through the heat treating chamber, and out the second opening for supporting the plurality of products. A conveyor motor is operably connected to the conveyor for transporting the plurality of products from the first opening, into the heat treating chamber, and out the second opening. A heating source and at least one finger duct are provided for directing heated air from the heating source onto the conveyor in the heat treating chamber of the housing for heating the plurality of products passing through the heat treating chamber. A shroud is disposed around the motor and includes at least one inlet and at least one outlet. A pair of fans are operably attached to a top of the shroud for forcing cooling air into the at least inlet, around the conveyor motor, and out the at least one outlet of the shroud for cooling the motor. An audio alarm is provided for alerting an operator of the oven of at least one of a malfunction with the pair of fans and an overheating condition of the conveyor motor.

The present invention, in a third aspect, is directed to a method for heat treating a plurality of products. The method includes providing an oven, providing a conveyor extending from a first opening, through a heat treating chamber, and out a second opening in the oven, applying heat to the plurality of products in the heat treating chamber, providing a conveyor motor for moving the conveyor to transport the plurality of products from the first opening, into the heat treating chamber, and out the second opening in the oven, and forcing cooling air around the conveyor motor for cooling the conveyor motor.

The present invention, in a fourth aspect, is directed to a method for heat treating a plurality of products. The method includes providing an oven, providing a conveyor extending from a first opening, through a heat treating chamber, and out a second opening in the oven, directing heated air from at least one finger duct onto the conveyor in the heat treating chamber of the oven, and providing a conveyor motor for moving the conveyor for transporting the plurality of products from the first opening, into the heat treating chamber, and out the second opening in the oven. A shroud is provided around the conveyor motor, and at least one fan is provided for forcing cooling air into the shroud, and around the conveyor motor, and out of the shroud for cooling the conveyor motor. An audio alarm is sounded for alerting an operator of the oven of at least one of a malfunction with the at least one fan and an overheating condition of the conveyor motor.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a front perspective view of one embodiment of a plurality of stacked ovens in accordance with the present invention;

FIG. 2 is a rear perspective view of the stacked ovens of FIG. 1;

FIG. 3 is an enlarged, perspective view of the conveyor motor and gearbox for one of the ovens of FIG. 1 with the shroud removed;

FIG. 4 is an enlarged, diagrammatic, side elevational view of a portion of one of the ovens of FIG. 1 having finger ducts and illustrating the flow of heated air through the heating chamber of the oven;

FIG. 5 is a top plan view of one of the shrouds and fans of FIG. 1;

FIG. 6 is an enlarged, rear elevational view of one of the shrouds of FIG. 1 illustrating the forced flow of air into the top of the shroud, around the conveyor motor, and out of the shroud in accordance with the present invention;

FIG. 7 is a rear elevational view of another embodiment of a shroud in accordance with the present invention;

FIG. 8 is a block diagram of the electrical components of the cooling apparatus for cooling the conveyor motor in accordance with the present invention;

FIG. 9 is an enlarged, rear elevational view of a portion of the control module of one of the ovens illustrating a control module fan and power junction box;

FIG. 10 illustrates a flowchart of one embodiment of a method in accordance with the present invention for heat treating a plurality of products; and

FIG. 11 illustrates a flowchart of another embodiment of a method in accordance with the present invention for heat treating a plurality of products.

### DETAILED DESCRIPTION OF THE INVENTION

The present invention is directed to ovens for heat treating products and may include food preparation ovens that use a gas power burner that meters combustible gas at a rate of up to about 200,000 BTU/hr.

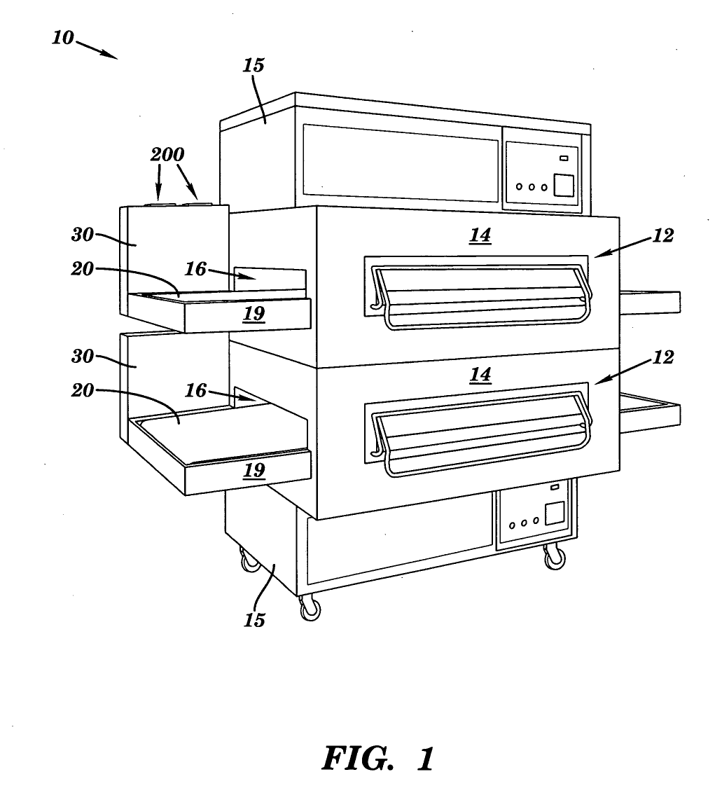

FIG. 1 illustrates a double stacked oven 10 in accordance with the present invention having first and second ovens 12 for heat treating products and may include ovens for preparing pizza and other types of food products. For example, a gas power burner may be used in an impingement oven having a conveyor 20 wherein food products are baked or cooked by means of jets of hot gaseous fluid such as hot air and wherein the hot air jets are impinged directly upon localized areas of the food product. Alternatively, an electrical heating element may be employed instead of the gas burner.

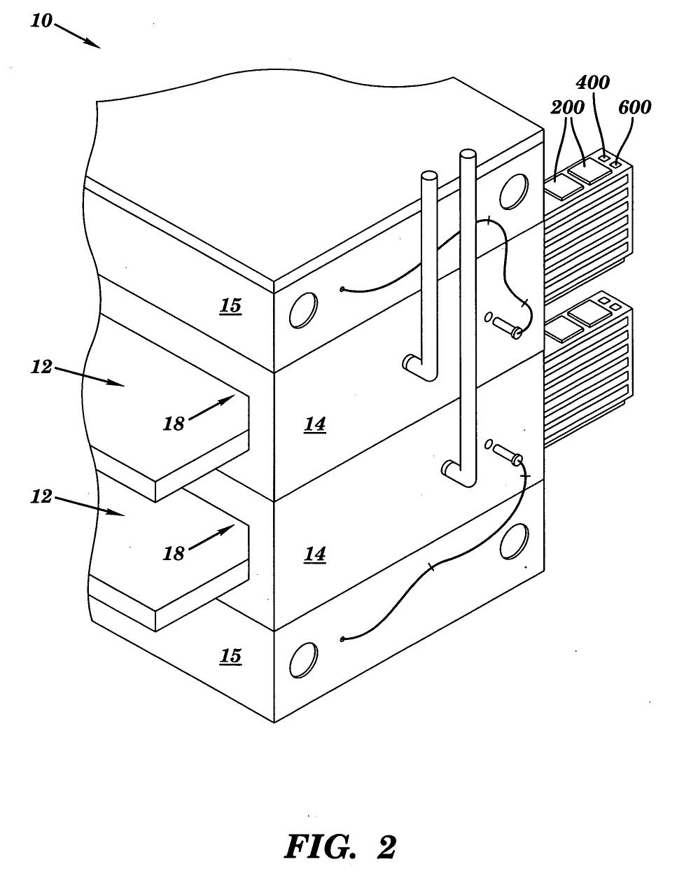

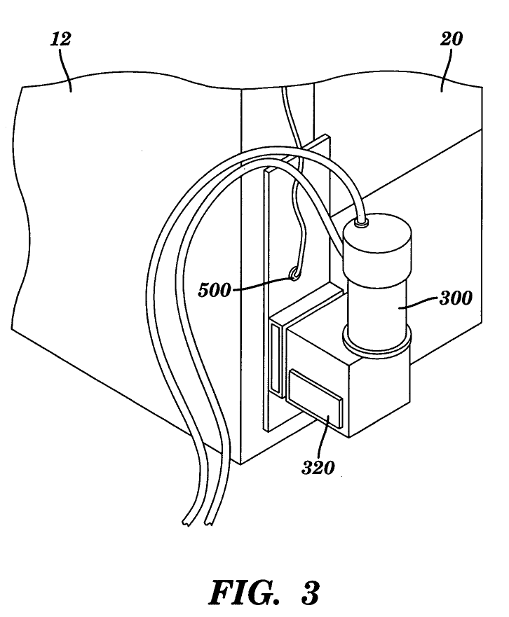

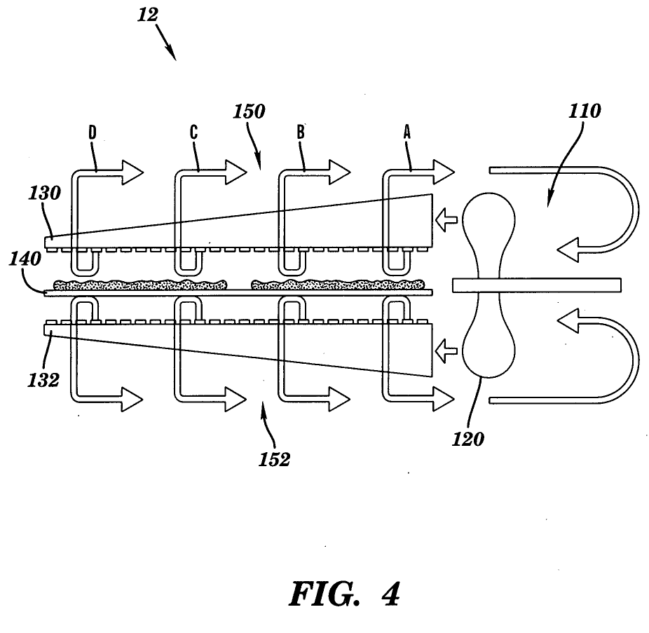

With reference to FIGS. 1-4, oven 12 may include, for example, a housing 14 and a control module 15. Housing 14 may include a first opening 16 (FIG. 1), a second opening 18 (FIG. 2), and a heat treating chamber 17 (FIG. 4) disposed between first opening 16 and second opening 18. Conveyor 20 extends from first opening 16, through heat treating chamber 17, and out second opening 18 for supporting the plurality of products. A conveyor motor 300 (FIG. 3) may be operably connected to the conveyor and disposed in a shroud 30 (FIG. 1). For example, conveyor motor 300 may be operably connected to a transmission or gearbox 320 and the gearbox may be suitably attached to the back of the oven, a tray 19 (FIG. 1) extending from the oven containing a portion of the conveyor, or disposed in another suitable location. The shaft of the conveyor motor may be operably connected to the gearbox. The gearbox, in turn, may be operably connected to a sprocket (not shown), which turns a chain (not shown) operably connected to conveyor 20 for transporting the plurality of products from the first opening, into the heat treating chamber, and out of the second opening.

With reference particularly to FIG. 4, in a portion of oven 12, air in a heating chamber 110 may be pressured by a circulatory fan 120 and forced into finger ducts 130 and 132 which extend into heat treating chamber 17. The heated pressurized air is forced through a plurality of opening in the finger ducts and directed towards a surface 140 to be heated. Thereafter, the air is directed around the sides of the finger ducts to cold air returns 150 and 152 for return to heating chamber 110 to be heated again and forced into the finger ducts 130 and 132 and into heat treating chamber 17.

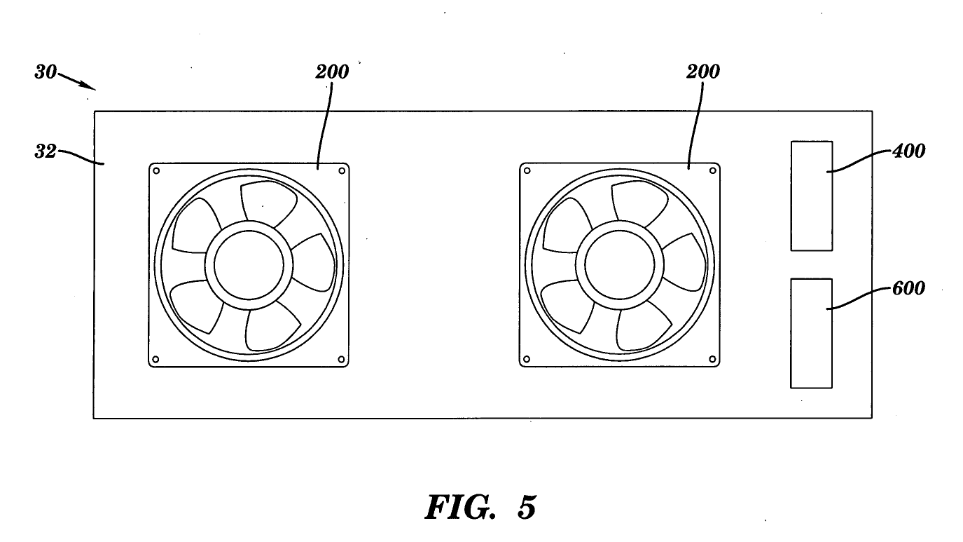

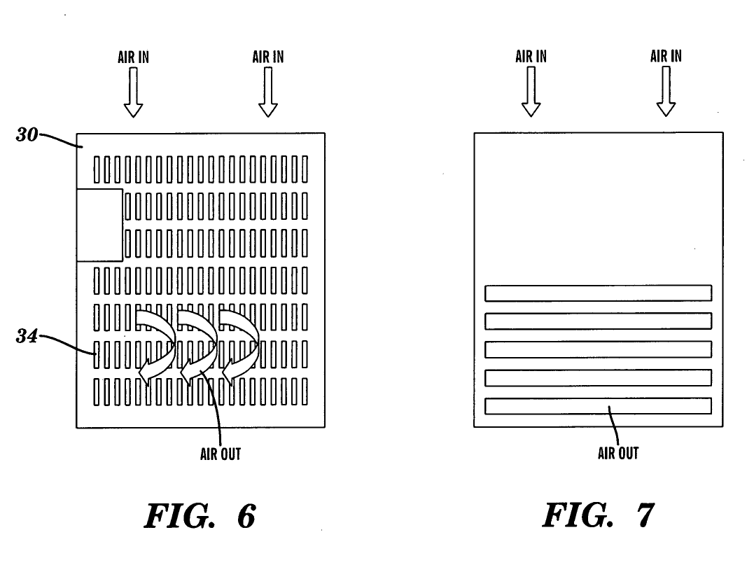

With reference to FIGS. 1, 2, and 5, in one embodiment of the present invention, at least one, and desirably a pair of fans 200 may be operably attached or mounted to a top horizontal member 32 of shroud 30 which shroud 30 is disposed around the conveyor motor and gearbox. As best shown in FIG. 6, shroud 30 may include at least one inlet (for example, the openings in the top horizontal member of the shroud 30 in which are disposed blowers or fans 200) and at least one outlet 34. The fan forcibly moves, such as draws in, the air into the at least one inlet, around said conveyor motor, and out of the at least one outlet of the shroud for cooling said conveyor motor, as illustrated by the arrows in FIG. 5.

As shown in FIG. 7, in another embodiment of the shroud, the upper rear portion of the shroud need not include any openings or louvers. In another embodiment, the shroud may be made smaller, e.g., the upper portion of the shroud in FIG. 7 may be eliminated so that the fans force cooling air directly onto the conveyor motor and gear box, which air then passes out of the shroud.

By providing the fans for forcibly drawing cooling air into the shroud and around the conveyor motor, the conveyor motor is cooled and the likelihood of the conveyor motor overheating and leaking oil is reduced compared to the use of conventional shrouds simply having openings such as louvers along the rear vertical surface of the shroud and in which air movement around the conveyor motor is due to natural connection of the heated air. By maintaining the conveyor motor at a lower temperature compared to the prior art, the present invention reduces the likelihood of oil leaking from the conveyor motor due to failure of the motor's bladder or resilient membrane that allows expansion of the oil in the motor in response to increased temperature of the conveyor motor.

An additional feature of the present invention may include an audio alarm 400, as shown in FIGS. 2 and 5, should the fan fail. For example, an audio alarm may be operably electrically connected to an electrical circuit or to a processor 600 so that if one of the fans fails, loses power, or otherwise fails to operate properly, an audio sound may be sounded to notify the operator of the oven. Further, an internal shroud temperature sensor 500, as shown in FIG. 3, may be provided for sensing the temperature adjacent to the conveyor motor. In one embodiment, a temperature sensor such as a thermal couple may be disposed adjacent to the conveyor motor and may be suitably connected to electrical circuitry, a microcontroller, or a processor 600, for example as shown in FIGS. 5 and 6, for activating the sounding the alarm if the temperature adjacent to the conveyor motor reaches a predetermined temperature. For example, the processor may compare the monitored temperature adjacent to the conveyor motor with a predetermined value. If the monitored value equals or is greater than the predetermined valve, the processor may operably activate the sounding of the alarm.

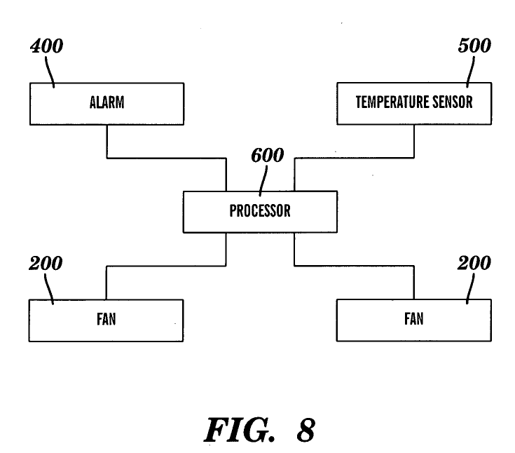

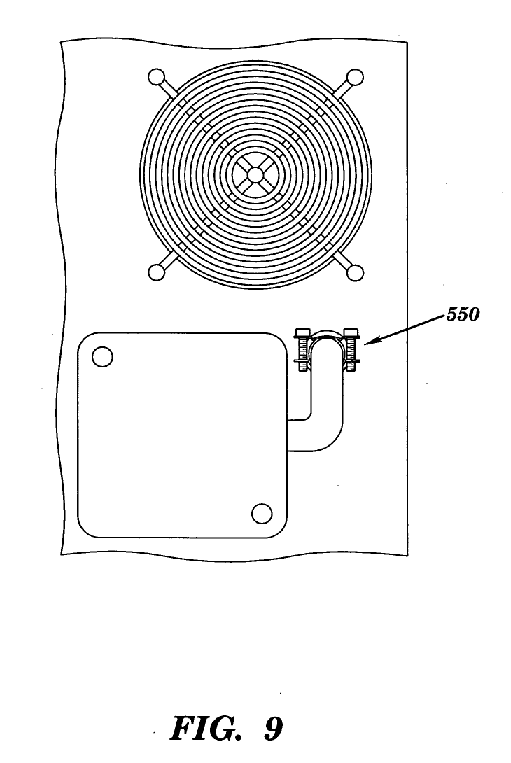

In addition, the monitoring of the temperature adjacent to the conveyor motor may be suitably employed using the temperature sensor and processor to vary the operation of the fans. For example, the speed of the fans may be varied based on the observed temperature. If the temperature rises, the electrical power to the fans may be increased to increase the speed of the fans, and thereby, increase the ability to cool the conveyor motor. Where the monitored temperature drops, the speed of the fans may be reduced. FIG. 8 illustrates a block diagram of the electrical components of the cooling apparatus for cooling the conveyor motor in accordance with the present invention.

With reference to FIG. 9, the fans may be operably electrically connected to an existing power source on the back of the oven, such as an electrical junction box 550 for powering a fan for cooling the control module of the oven.

The use of two fans in the shroud provides redundancy should one of the fans fail. From the present description, it will be appreciated that other means for pressurizing and/or forcibly moving the air into and out of the shroud and around the conveyor motor may be employed. Such other means may include axial fans, squirrel fans, or centrifugal blowers. Suitable fans may include axial fans sized at 4½ inch by 4½ inch and 300 CFM. It will also be appreciated that the fans may be disposed in other locations on the shroud than that described above.

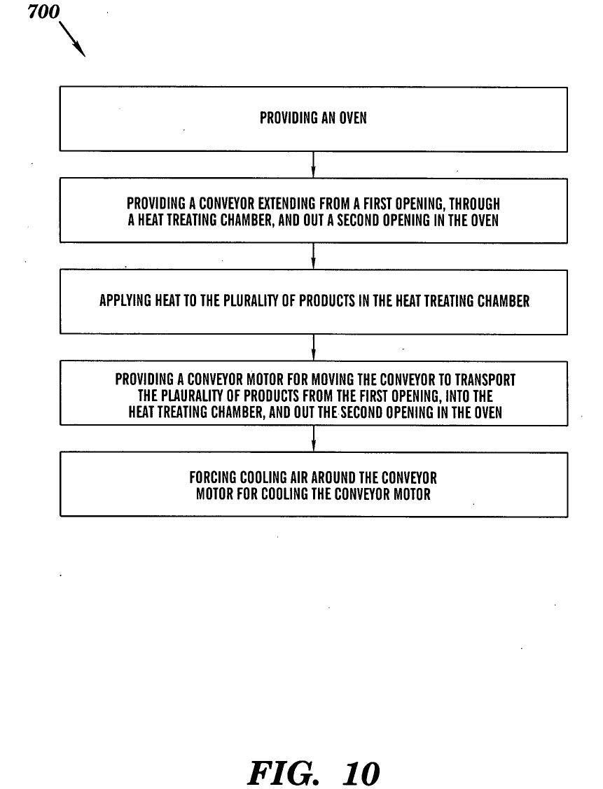

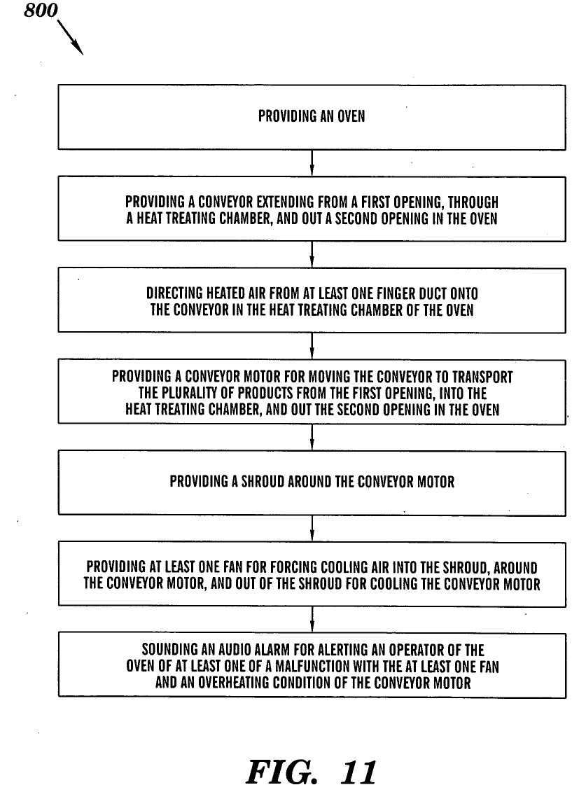

FIG. 10 illustrates a flowchart for one embodiment of a method 700 in accordance with the present invention for heat treating a plurality of products. FIG. 11 illustrates a flowchart of another embodiment of a method 800 in accordance with the present invention for heat treating a plurality of products.

The various components of the present invention described above may be incorporated into the food preparation ovens disclosed in U.S. Pat. No. 4,846,143 issued to Csadenyl, and U.S. Pat. No. 5,025,775 issued to Crisp, the entire subject matter of these patents being incorporated herein by reference. In addition, the various components of the present invention described above may be incorporated into the food preparation ovens disclosed U.S. patent application Ser. No. 12/111,490, entitled “Ovens, Burner Tube Assemblies, And Methods For Delivering Air To A Gas Power Burner,” by Bramhall; U.S. patent application Ser. No. 12/111,497, entitled “Ovens Having A Cold Air Return Baffle And Methods For Circulating Air In An Oven,” by Bramhall; U.S. patent application Ser. No. 12/111,501, entitled “Ovens, Finger Ducts Therefor, And Methods For Distributing Air in A Finger Duct” by Bramhall; and U.S. patent application Ser. No. 12/111,506, entitled “Methods For Moving Ovens, And Ovens Having Means For Releasably Attaching To A Plurality Of Casters,” by Bramhall, which applications are hereby incorporated in their entirety herein by reference.

Thus, while various embodiments of the present invention have been illustrated and described, it will be appreciated to those skilled in the art that many changes and modifications may be made thereunto without departing from the spirit and scope of the invention.

1. An oven for heat treating a plurality of products, said oven comprising:
a housing having a first opening, a second opening, and a heat treating chamber disposed between said first opening and said second opening;
a conveyor extending from said first opening, through said heat treating chamber, and out said second opening for supporting the plurality of products;
a conveyor motor operably connected to said conveyor for transporting the plurality of products from said first opening, into said heat treating chamber, and out said second opening;
a heating source for heating the plurality of products passing through said heat treating chamber;
a shroud disposed around said conveyor motor, said shroud having at least one inlet and at least one outlet; and
at least one fan for forcing cooling air into said at least one inlet, around said conveyor motor, and out said at least one outlet of the shroud for cooling said conveyor motor.

2. The oven of claim 1 wherein said at least one fan comprises at least two fans for forcing cooling air into said at least one inlet, around said conveyor motor, and out said at least one outlet of said shroud for cooling said conveyor motor.

3. The oven of claim 1 wherein said at least one fan is operable to draw air into said at least one inlet and exhaust air from said at least one outlet of said shroud.

4. The oven of claim 1 wherein said at least one inlet is disposed on a top horizontal member of said shroud.

5. The oven of claim 1 further comprising an audio alarm for alerting an operator of said oven of at least one of a malfunction with said at least one fan and an overheating condition of said conveyor motor.

6. The oven of claim 5 wherein said alarm is attached to said shroud.

7. The oven of claim 1 further comprising a temperature sensor for sensing temperature adjacent to said conveyor motor.

8. The oven of claim 7 further comprising an audio alarm and a processor operable connected to said temperature sensor for monitoring the temperature adjacent to said conveyor motor and signaling activation of said alarm based on the monitored temperature.

9. The oven of claim 7 further comprising a processor for operably regulating the speed of at least one fan based on the monitored temperature.

10. An oven for heat treating a plurality of products, said oven comprising:
a housing having a first opening, a second opening, and a heat treating chamber disposed between said first opening and said second opening;
a conveyor extending from said first opening, through said heat treating chamber, and out said second opening for supporting the plurality of products;
a conveyor motor operably connected to said conveyor for transporting the plurality of products from said first opening, into said heat treating chamber, and out said second opening;
a heating source;
at least one finger duct for directing heated air from said heating source onto said conveyor in said heat treating chamber of said housing for heating and plurality of products passing through said heat treating chamber;
a shroud disposed around said conveyor motor, said shroud having at least one inlet and at least one outlet;
a pair of fans operably attached to a top of said shroud for forcing cooling air into said at least one inlet, around said conveyor motor, and out said at least one outlet of the shroud for cooling said conveyor motor; and
an audio alarm for alerting an operator of said oven of at least one of a malfunction with at least one of said pair of fans and an overheating condition of said conveyor motor.

11. The oven of claim 10 further comprising a temperature sensor for sensing temperature adjacent to said conveyor motor, and a processor operable connected to said temperature sensor for monitoring the temperature adjacent to said conveyor motor and signaling activation of said alarm based on the monitored temperature.

12. The oven of claim 10 further comprising a temperature sensor for sensing temperature adjacent to said conveyor motor and a processor for operably regulating the speed of the pair of fans based on the monitored temperature.

13. A method heat treating a plurality of products, the method comprising:
providing an oven;
providing a conveyor extending from a first opening, through a heat treating chamber, and out a second opening in the oven;
applying heat to the plurality of products in the heat treating chamber;
providing a conveyor motor for moving the conveyor to transport the plurality of products from the first opening, into the heat treating chamber, and out the second opening in the oven; and
forcing cooling air around the conveyor motor for cooling the conveyor motor.

14. The method of claim 13 further comprising providing a shroud around the conveyor motor, and wherein the forcing cooling air comprises forcing cooling cooling air into and out of the shroud.

15. The method of claim 13 wherein the forcing cooling air comprises providing at least one fan for forcing the cooling air around the conveyor motor.

16. The method of claim 15 further comprising sounding an audio alarm for alerting an operator of the oven of at least one of a malfunction with fan and an overheating condition of the conveyor motor.

17. The method of claim 13 wherein the forcing cooling air comprises providing a pair of fans for forcing the cooling air around the conveyor motor.

18. The method of claim 17 further comprising sounding an audio alarm for alerting an operator of the oven of at least one of a malfunction with the pair of fans and an overheating condition of the conveyor motor.

19. The method of claim 13 further comprising monitoring the temperature adjacent to the conveyor motor and wherein the forcing cooling air comprises varying the flow of the cooling air ground the conveyor motor based on the monitored temperature.

20. The method of claim 13 further comprising monitoring the temperature adjacent to the conveyor motor and wherein the forcing cooling air comprises varying the flow of the cooling air ground the conveyor motor based on the monitored temperature.

21. A method heat treating a plurality of products, the method comprising:
providing an oven;
providing a conveyor extending from a first opening, through a heat treating chamber, and out a second opening in the oven;
directing heated air from at least one finger duct onto the conveyor in the heat treating chamber of the oven;
providing a conveyor motor for moving the conveyor to transport the plurality of products from the first opening, into the heat treating chamber, and out the second opening in the oven;
providing a shroud around the conveyor motor;
providing at least one fan for forcing cooling air into the shroud, around the conveyor motor, and out of the shroud for cooling the conveyor motor; and
sounding an audio alarm for alerting an operator of the oven of at least one of a malfunction with the at least one fan and an overheating condition of the conveyor motor.

22. The method of claim 21 wherein the providing at least one fan comprises providing a pair of fans for forcibly moving air into the shroud, around the conveyor motor, and out of the shroud for cooling the conveyor motor.

23. The method of claim 21 further comprising monitoring the temperature adjacent to the conveyor motor and signaling activation of the alarm based on the monitored temperature.

24. The method of claim 21 further comprising monitoring the temperature adjacent to the conveyor motor and wherein the forcing cooling air comprises varying the flow of the cooling air ground the conveyor motor based on the monitored temperature.
